(19) United States
(12) Patent Application Publication
(10) Pub. No.: US 2017/0231189 A1
(43) Pub. Date: Aug. 17, 2017

(54) PET POTTY

(71) Applicant: Diane Pfister, Southbury, CT (US)

(72) Inventor: Diane Pfister, Southbury, CT (US)

(21) Appl. No.: 15/043,567

(22) Filed: Feb. 14, 2016

(51) Int. Cl. A01K 1/01

(52) U.S. Cl. CPC A01K 1/011

(57) ABSTRACT

This invention will provide an elective system for pets to use whenever they want. The system provides a safe clean way for animal waste to join the human waste disposal system without kitty litter or having to walk the animal and scoop poop. The cruelty of making a dog wait till you are home to walk will be ended and something more humane and advanced than scooping on city streets will be available.

### BACKGROUND OF THE INVENTION

This invention is to address what I see is a need for allowing pets to use bathroom facilities in the home. Urban settings and 2 working spouses in homes leaves abusive situations for pets not to be able to relieve themselves when they want. Having to keep a dog limited to two times a day to relieve themselves is cruel. This invention allows an animal to decide when they need to go and does not require them to go out in the rain, when they are sick or old. It allows them to go whenever they want whether someone is home or not. With timed food and water delivery systems already available, people can go away for longer times without the guilt of leaving them cooped up and waiting to go outside to relieve themselves. For the cat, kitty litters are a smelly expensive mess that require every other day attention. If you have more than one cat, it is daily attention. This system has no need for heavy kitty litter boxes.

Both the owners and the pets win with this system. There is no smell, minimal cleaning, and it gives the animal comfort in the home.

### BRIEF SUMMARY OF THE INVENTION

This system allows pet dogs and cats to use a toilet on the floor in the bathroom that automatically flushes after they leave the space. This means they can go whenever they want and there is no need to walk dogs in bad weather, or when they are old and/or sick.

### BRIEF DESCRIPTION OF THE SEVERAL VIEWS OF THE DRAWING

FIG. 1: Padded Cushion plate around the flushing bowl contains the trigger sensor to instigate a delayed flushing system. The delay would be set to 3-5 minutes, allowing the animal to relieve themselves and leave before the flushing mechanism is triggered.

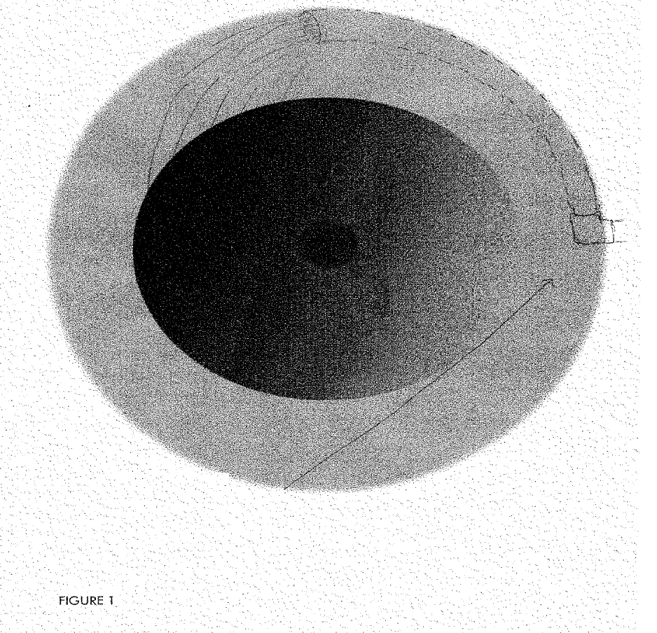

FIG. 2: This trigger could also be an electric eye system that when triggered. delays then creates the flush. These two options will provide different price points for the client.

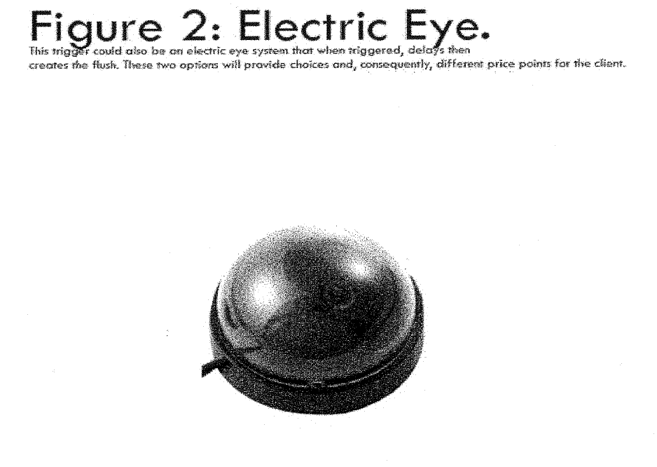

FIG. 3: Bowl with flushing system indicating the water intake pipe that connects to the toilet water intake pipe and the waste removal pipe that connects to the toilet waste removal pipe.

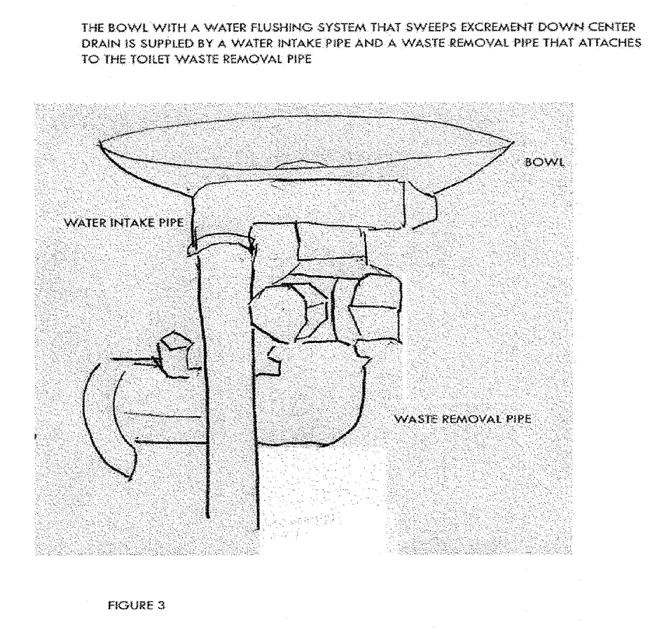

FIG. 4: Profile installation shows how it connects to the already existing toilet features of water input and waste removal

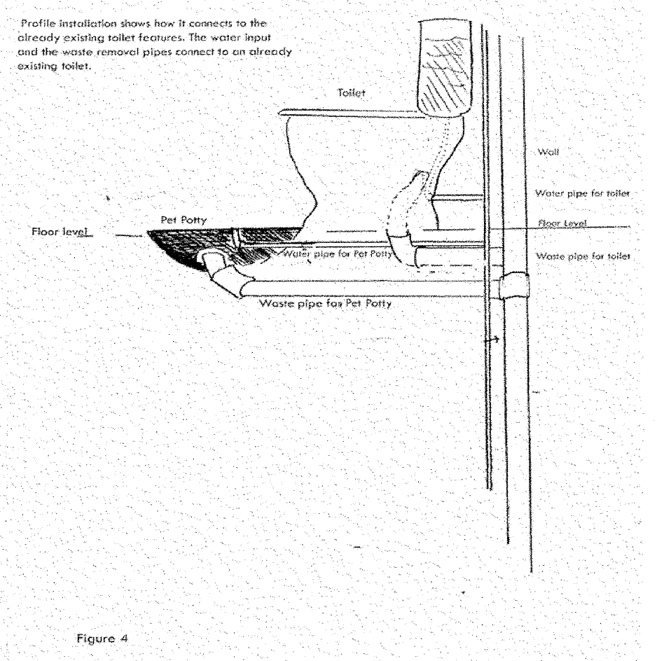

FIG. 5: Backsplash unit has water pipe behind that flushes down the unit after an animal has urinated on the wall. Is only useful for male dogs.

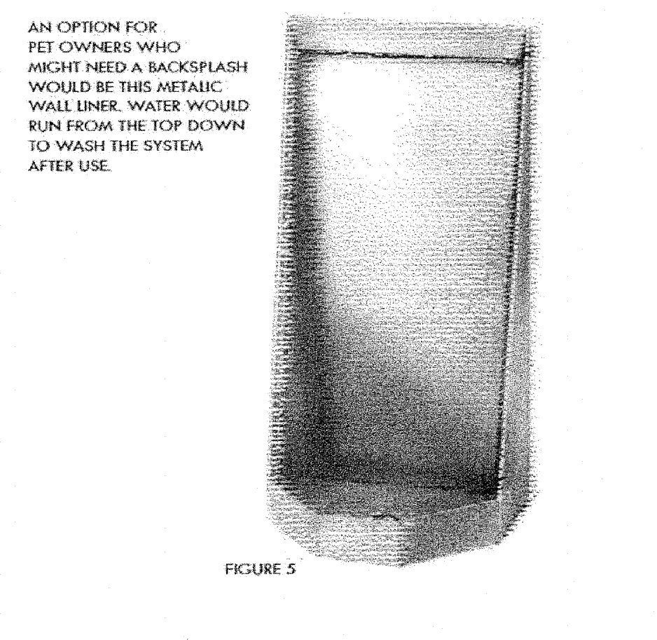

### DETAILED DESCRIPTION OF THE INVENTION

Triggering the flush system will be based on two possible systems:

1. Surrounding the sink with a pressure sensitive cushion. The first press will turn on the system for a delayed flush after four minutes.

2. Electric eye will perceive something on the sink and activate a delayed system of flush after four minutes.

The design drawn shows a circular sink that will be recessed in the floor, either near the toilet, or in a closet. The drainpipe will attach to the waste removal pipe of the toilet.

The water source pipe will attach to the water source pipe of the toilet.

The size will be 2 feet in diameter for larger pets. Those people with only cats and limited space will have a 1-foot diameter.

To train cats to use it, it will first function as as a litter tray. A protective seal will keep the kitty litter from going down the drain. When the cat is acclimated to the space, less and less kitty litter can be used. Eventually cut up plastic bags will replace the kitty litter, and the clear protective lining will be removed. Then the sensor will be turned on and soon enough the pet will know to go there with no kitty litter.

To train dogs, patience is needed to teach a word that means to relieve themselves while they are on a leash outside. Something like “do your business” is said when they have their nose down to sniff a place. Once they relieve themselves praise and a treat are given. Soon the word is associated with relieving themselves. Once inside, using that word with a treat will teach them that is the space to use. Incorporating examples of past excrement to the bowl will help with this association. Once the pet has used it properly, praise and a treat are given. This must continue for some time till eventually the pet knows they can go anytime and the system is available in the home 24/7.

### Construction:

The bowl will be of a ceramic mold glazed

The connecting units will be of PVC piping.

The cushion (if used) will be vinyl covered templates that electrically respond to the pressure of the pets feet. This could also be an electric eye system that triggers a delayed flushing.

1. I claim that this pet toilet system based on the traditional human toilet system is my invention: My hope is that it will become a standard issue element in luxury designed homes. Urban areas where twice daily walking a pet or having a litter tray in small spaces will appreciate having this option. Smells of litter trays will no longer be an issue. This toilet will work.
